(19) United States
(12) Patent Application Publication
(10) Pub. No.: US 2025/0056347 A1
(43) Pub. Date: Feb. 13, 2025

(54) PERFORMING L1/L2-triggered mobility, LTM, MEASUREMENTS

(71) Applicant: Nokia Technologies Oy, Espoo (FI)

(72) Inventors: Lars Dalsgaard, Oulu (FI); Riikka Karoliina Dimnik, Espoo (FI); Jani-Pekka Kainulainen, Cambridge (GB)

(21) Appl. No.: 18/785,465

(22) Filed: Jul. 26, 2024

(30) Foreign Application Priority Data
Aug. 10, 2023 (GB) 2312275.7

(51) Int. Cl. H04W 36/04; H04W 36/00; H04W 76/28

(52) U.S. Cl. CPC H04W 36/04; H04W 36/0058; H04W 76/28

(57) ABSTRACT

An apparatus comprising means for:
determining whether a user equipment, UE, is in an active period;
causing performance, by the UE, of L1/L2-Triggered Mobility, LTM, assistance measurements when the UE is in an active period; and
stopping performance, by the UE, of LTM assistance measurements when the UE is not in an active period.

### TECHNOLOGICAL FIELD

Examples of the disclosure relate to performing L1/L2-triggered mobility, LTM, measurements.

### BACKGROUND

A wireless network comprises a plurality of network nodes including terminal nodes and access nodes. Communication between the terminal nodes and access nodes is wireless.

In some circumstances it may be desirable to improve or enhance performance of measurements at a terminal node.

### BRIEF SUMMARY

According to various, but not necessarily all, embodiments there is provided an apparatus comprising means for:
determining whether a user equipment, UE, is in an active period;
causing performance, by the UE, of L1/L2-Triggered Mobility, LTM, assistance measurements when the UE is in an active period; and
stopping performance, by the UE, of LTM assistance measurements when the UE is not in an active period.

In some examples, the UE is configured for discontinuous reception, DRX, and wherein determining whether the UE is in the active period comprises determining whether the UE is in a DRX active period.

In some examples, determining whether the UE is in the active period comprises determining whether an inactivity timer is running at the UE, wherein the UE is in the active period when the inactivity timer is running at the UE.

In some examples, the means are configured to:
determine whether a request has been made for the UE to start performing LTM assistance measurements; and
cause performance, by the UE, of LTM assistance measurements based, at least in part, on determining whether a request has been made for the UE to start performing LTM assistance measurements.

In some examples, determining whether the UE is in the active period comprises determining whether an extension timer is running at the UE, wherein the UE is in the active period when the extension timer is running at the UE.

In some examples, the means are configured to receive a configuration of the extension timer.

In some examples, the means are configured to:
start the extension timer when an inactivity timer is started or when an inactivity timer expires.

In some examples, the means are configured to:
receive a request to start the extension timer; and
start the extension timer based, at least in part, on receiving the request to start the extension timer.

In some examples, the extension timer has a configured duration.

In some examples, the means are configured to:
receive a request to stop the extension timer; and
stop the extension timer based, at least in part, on receiving the request to stop the extension timer.

In some examples, the means are configured to:
receive a request to continue causing performance, by the UE, of LTM assistance measurements until a request to stop is received or the UE leaves connected mode.

In some examples, the means are configured to:
determine that at least one LTM assistance measurement condition is satisfied; and
cause performance, by the UE, of LTM assistance measurements based, at least in part, on determining that at least one LTM assistance measurement condition is satisfied.

In some examples, causing performance, by the UE, of LTM assistance measurements comprises causing performance, by the UE, of LTM assistance measurements according to an LTM measurement configuration.

In some examples, the means are configured to:
cause transmission of at least one measurement report based, at least in part, on at least part of the LTM assistance measurements.

In some examples, the means comprise:
at least one processor; and
at least one memory storing instructions that, when executed by the at least one processor, cause the performance of the apparatus.

According to various, but not necessarily all, embodiments there is provided an electronic device comprising an apparatus as described herein.

According to various, but not necessarily all, embodiments there is provided a method comprising:
determining whether a user equipment, UE, is in an active period;
causing performance, by the UE, of L1/L2-Triggered Mobility, LTM, assistance measurements when the UE is in an active period; and
stopping performance, by the UE, of LTM assistance measurements when the UE is not in an active period.

In some examples, the UE is configured for discontinuous reception, DRX, and wherein determining whether the UE is in an active period comprises determining whether the UE is in a DRX active period.

In some examples, determining whether the UE is in an active period comprises determining whether an inactivity timer is running at the UE, wherein the UE is in an active period when the inactivity timer is running at the UE.

In some examples, the method comprises:
determining whether a request has been made for the UE to start performing LTM assistance measurements; and
causing performance, by the UE, of LTM assistance measurements based, at least in part, on determining whether a request has been made for the UE to start performing LTM assistance measurements.

In some examples, determining whether the UE is in an active period comprises determining whether an extension timer is running at the UE, wherein the UE is in an active period when the extension timer is running at the UE.

In some examples, the method comprises:
starting the extension timer when an inactivity timer is started or when an inactivity timer expires.

According to various, but not necessarily all, embodiments there is provided a computer program comprising instructions for causing an apparatus to perform:
determining whether a user equipment, UE, is in an active period;
causing performance, by the UE, of L1/L2-Triggered Mobility, LTM, assistance measurements when the UE is in an active period; and
stopping performance, by the UE, of LTM assistance measurements when the UE is not in an active period.

In some examples, determining whether the UE is in an active period comprises determining whether the UE is in a DRX active period.

According to various, but not necessarily all, embodiments there is provided an apparatus comprising means for:
causing transmission, towards a UE of a request to continue performing LTM assistance measurements; and
causing transmission, towards the UE, of a request to stop performing LTM assistance measurements.

In some examples, causing transmission, towards the UE, of a request to continue performing LTM assistance measurements comprises causing transmission, to the UE, of a request to start an extension timer; and
wherein causing transmission, towards the UE, of a request to stop performing LTM assistance measurements comprises causing transmission, to the UE, of a request to stop the extension timer.

According to various, but not necessarily all, examples there is provided examples as claimed in the appended claims.

According to various, but not necessarily all, embodiments there is provided an apparatus comprising
at least one processor; and
at least one memory including computer program code;
the at least one memory storing instructions that, when executed by the at least one processor, cause the apparatus at least to perform at least a part of one or more methods disclosed herein.

According to various, but not necessarily all, embodiments there is provided an apparatus comprising means for performing at least part of one or more methods disclosed herein.

The description of any function and/or action should additionally be considered to also disclose any means suitable for performing that function and/or action.

Functions and/or actions described herein can be performed in any suitable way using any suitable method.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

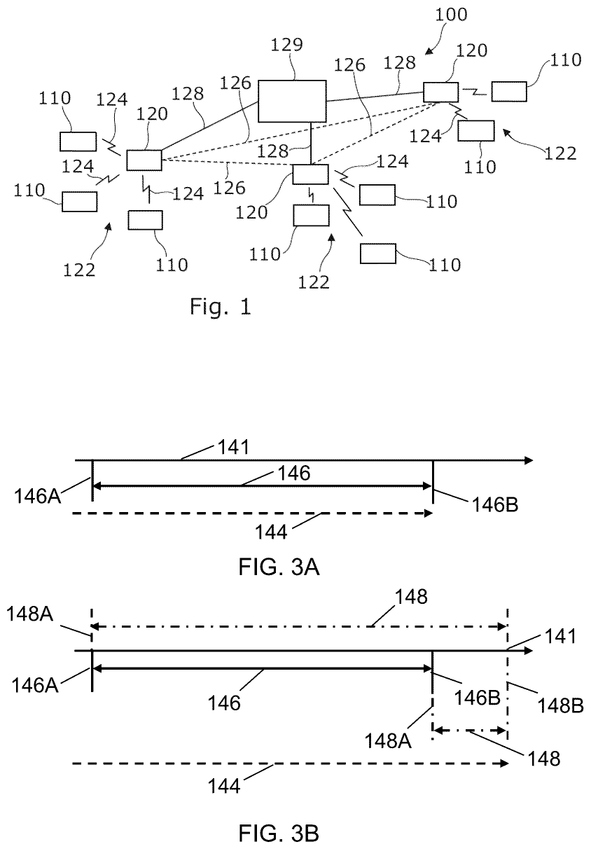

FIG. 1 shows, by way of example, a network architecture of a communication system;

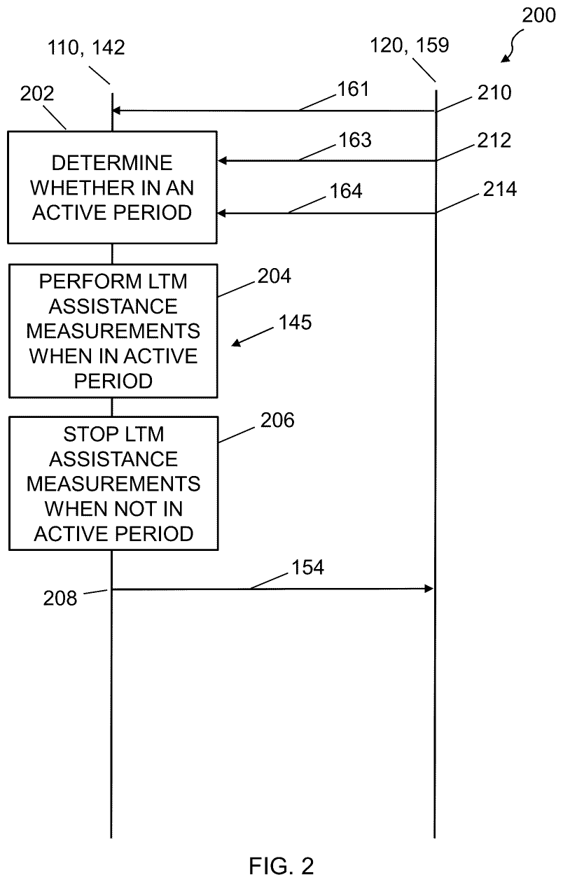

FIG. 2 shows, by way of example, signalling between entities;

FIG. 3A shows, by way of example, a timeline of an inactivity timer;

FIG. 3B shows by way of example, a timeline of an inactivity timer;

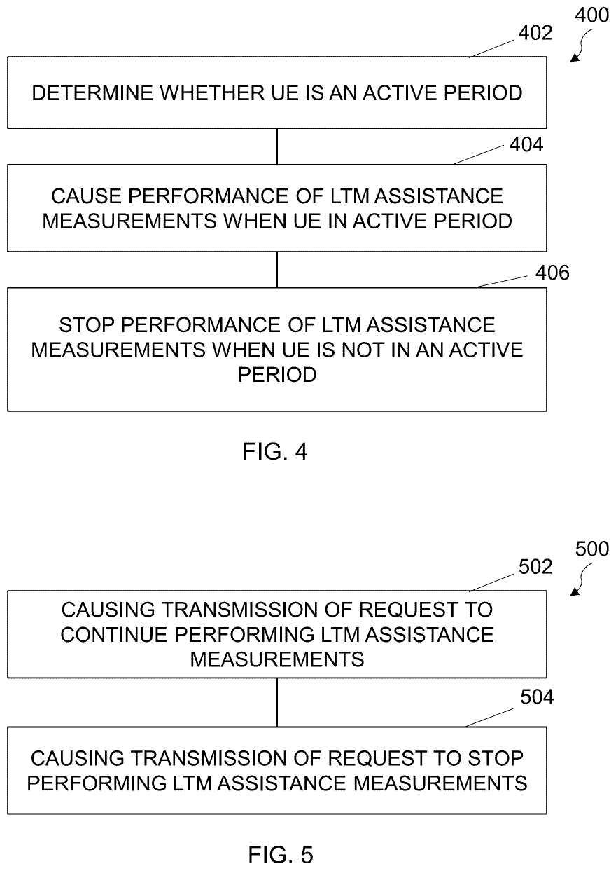

FIG. 4 shows, by way of example, a flowchart of a method;

FIG. 5 shows, by way of example, a flowchart of a method;

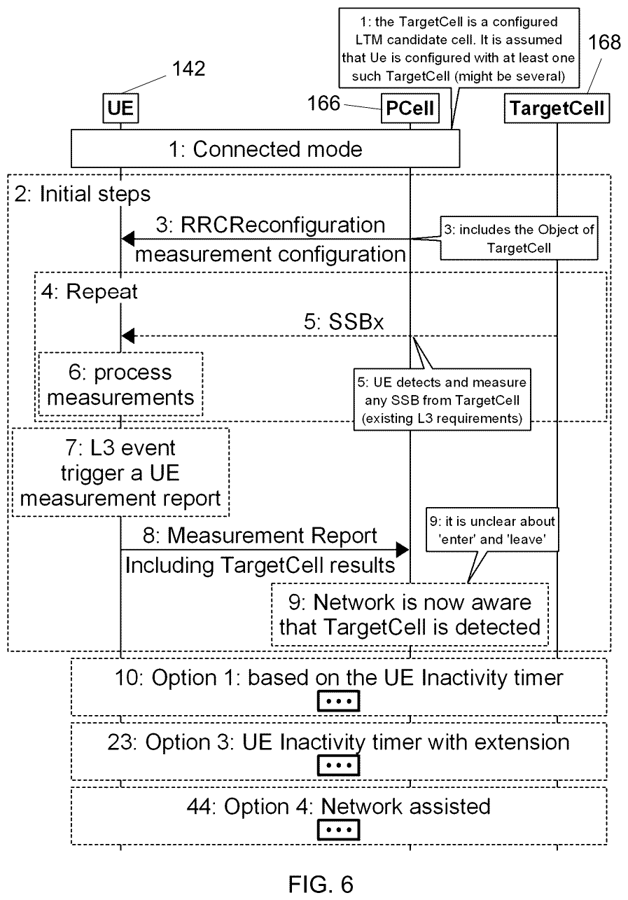

FIG. 6 shows, by way of example, signalling between entities;

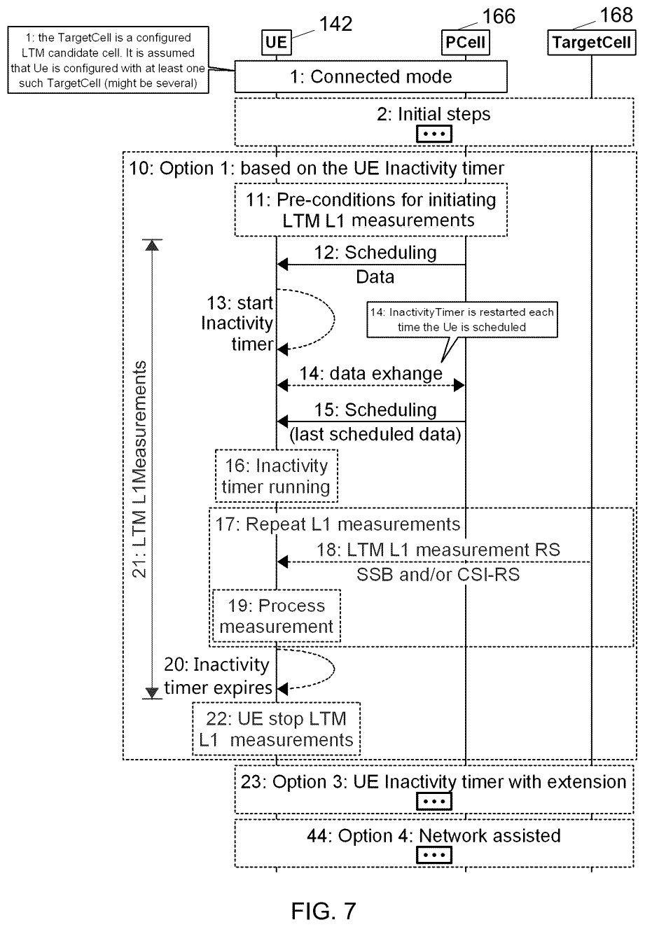

FIG. 7 shows, by way of example, signalling between entities;

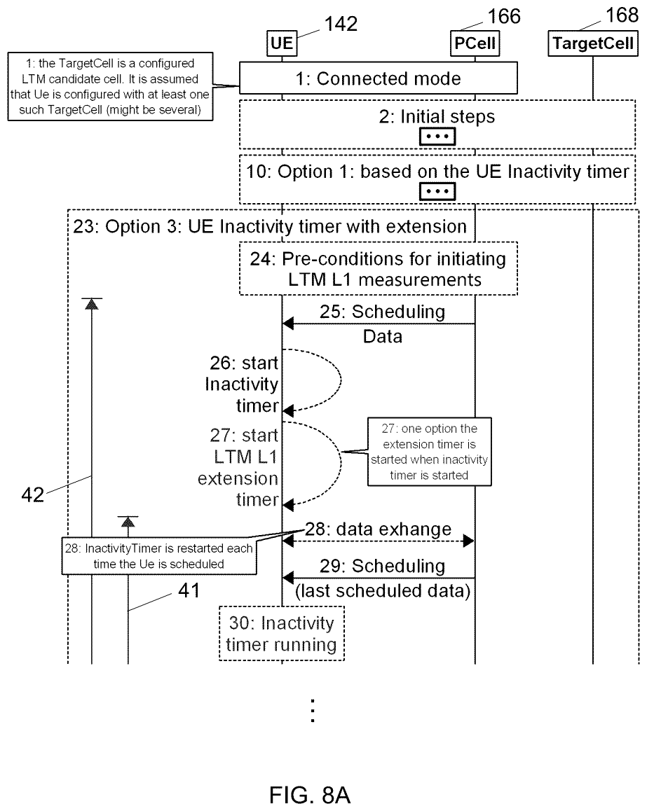

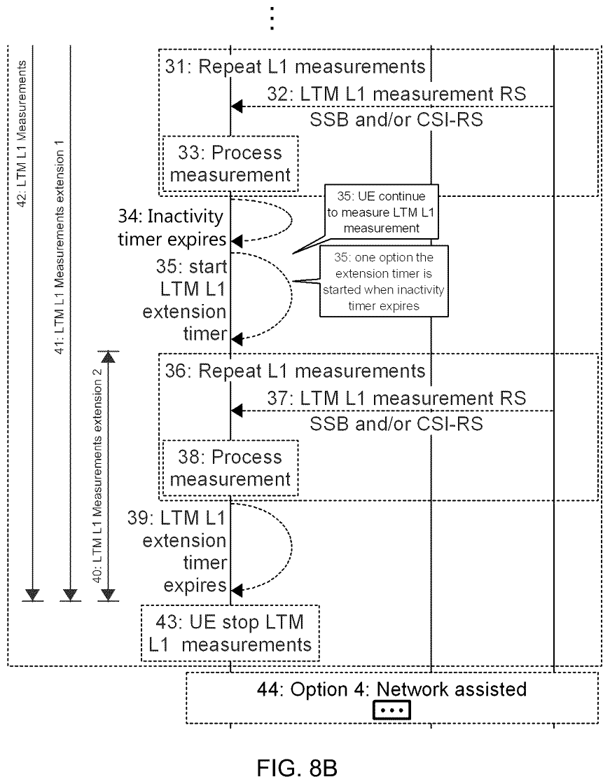

FIG. 8A shows, by way of example, signalling between entities;

FIG. 8B shows, by way of example, signalling between entities;

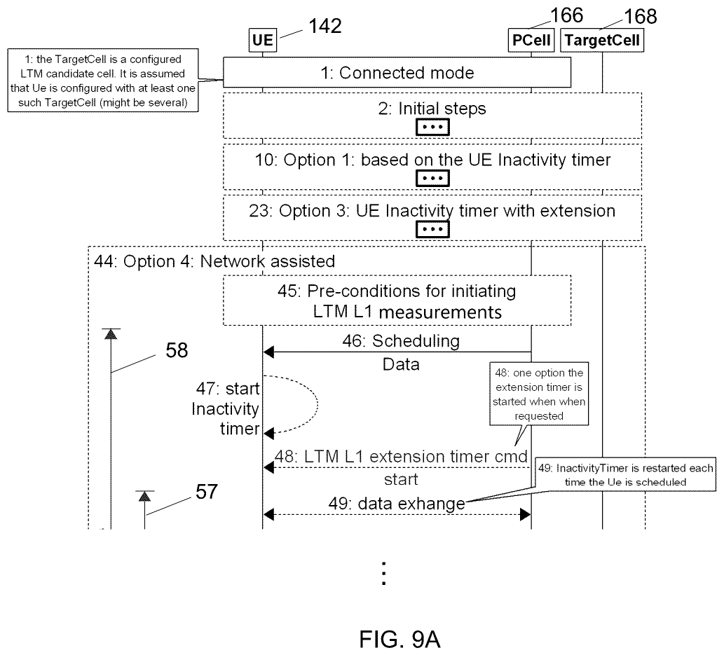

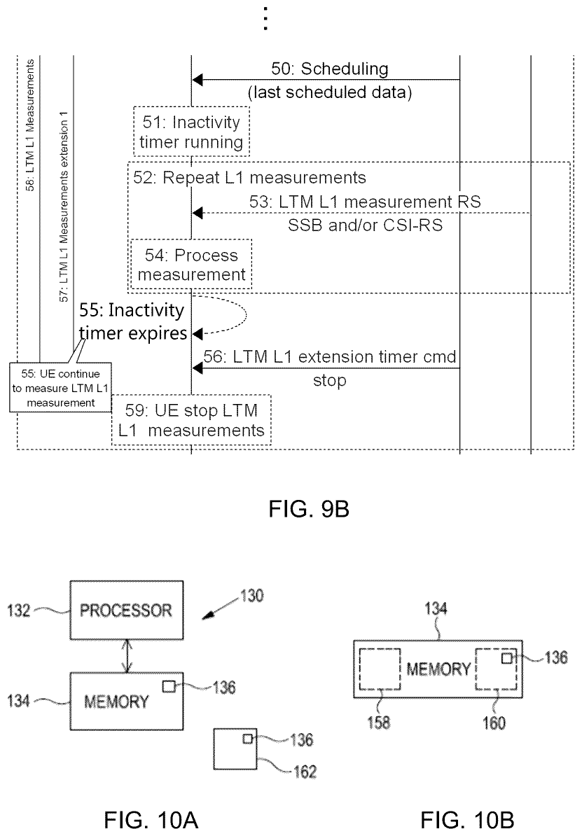

FIG. 9A shows, by way of example, signalling between entities;

FIG. 9B shows, by way of example, signalling between entities;

FIG. 10A shows, by way of example, a block diagram of an apparatus; and

FIG. 10B shows, by way of example, a memory.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) 142 (see, for example, FIG. 2) and the access nodes 120 are base stations.

In examples the network 100 is an Evolved Universal Terrestrial Radio Access network (E-UTRAN). The E-UTRAN consists of E-UTRAN NodeBs (eNBs), providing the E-UTRA user plane and control plane (radio resource control, RRC) protocol terminations towards the UE 142. The eNBs are interconnected with each other by means of an X2 interface 126. The eNBs are also connected by means of the S1 interface 128 to the Mobility Management Entity (MME) 129.

In other examples the network 100 is a Next Generation (or New Radio, NR) Radio Access network (NG-RAN). The NG-RAN consists of gNodeBs (gNBs) 120, providing the user plane and control plane (RRC) protocol terminations towards the UE 142. The gNBs are interconnected with each other by means of an Xn interface 126. The gNBs are also connected by means of the N2 interface 128 to the Access and Mobility management Function (AMF).

In examples, the network 100 can comprise a combination of E-UTRAN and NG-RAN.

A user equipment 142 (UE) can comprise a mobile equipment. Where reference is made to user equipment that reference includes and encompasses, wherever possible, a reference to mobile equipment.

A terminal node 110, for example a UE 142, can perform measurements to assess the operating radio environment of the terminal node 110. For example, the terminal node 110 can perform measurements for use in mobility, such as measurements involved in handover.

A terminal node 110, for example a UE 142, can perform measurements for use in and/or involved in Lower Layer Triggered Mobility (LTM). In examples, Lower Layer Triggered Mobility can be considered L1/L2 Triggered Mobility (LTM). In examples, lower layer triggered mobility, LTM, measurements may be referred to as L1/L2 triggered mobility measurements. In examples, lower layer triggered mobility, LTM, assistance measurements may be referred to as L1/L2 triggered mobility assistance measurements.

In examples, a terminal node 110, for example a UE 142, can be controlled to perform measurements for use in and/or involved in LTM based, at least in part, on activity between the terminal node 110 and the network, for example a gNB.

Examples of the disclosure relate to apparatuses, methods, and/or computer programs for and/or involved in performance of measurements associated with and/or involved in LTM.

Additionally, or alternatively, examples of the disclosure relate to apparatuses, methods, and/or computer programs for and/or involved in controlling a UE to perform measurements associated with and/or involved in LTM.

Additionally, or alternatively, examples of the disclosure relate to apparatuses, methods, and/or computer programs for and/or involved in controlling when a UE performs measurements for and/or involved in LTM based, at least in part, on activity between a UE and an access node, such as a gNB.

FIG. 2 illustrates, by way of example, signalling between entities. FIG. 2 also illustrates an example of a method 200.

In examples, FIG. 2 can be considered to illustrate a plurality of methods. For example, FIG. 2 illustrates one or more actions at a plurality of actors/entities and, in examples, FIG. 2 can be considered to illustrate a plurality of methods performed by the individual actors/entities.

One or more of the features discussed in relation to FIG. 2 can be found in one or more of the other FIGS.

In the example of FIG. 2, a plurality of apparatuses transmit and/or receive one more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of network 100 as described in relation to FIG. 1.

In the illustrated example, a terminal node 110 and an access node 120 transmit and/or receive one or more signals and/or one or more messages. For example, the network node may comprise a gNodeB 159 (gNB) and the terminal node 110 may comprise a UE 142.

In examples, communications and/or transmissions between entities illustrated in FIG. 2 can proceed via any number of intervening entities, or including no intervening entities.

Although one terminal node 110 is illustrated in the example of FIG. 2, in examples any suitable number of terminal nodes 110, for example UEs 142, can be included. Similarly, in examples, any suitable number of access nodes 120 can be included.

As described herein, a description of a function and/or action should also be considered to disclose enabling, and/or causing, and/or controlling that function and/or action. For example, a description of transmitting information should also be considered to disclose enabling, and/or causing, and/or controlling transmitting/transmission of information.

For example, a description of an apparatus, such as a UE 142, transmitting information should also be considered to disclose at least one controller of the apparatus enabling, and/or causing, and/or controlling the apparatus to transmit the information.

The above paragraphs concerning FIG. 2 can apply similarly to FIGS. 6, 7, 8A, 8B, 9A, and 9B.

In examples, method 200 and/or at least a part of method 200 can be considered a method of controlling performance of measurements associated with and/or involved in LTM.

In examples, method 200 and/or at least a part of method 200 can be considered a method of efficiently enabling LTM.

In examples, method 200 and/or at least a part of method 200 can be considered a method of performing measurements associated with and/or involved in LTM based, at least in part, on activity between a terminal node 100, such as a UE 142, and an access node 120, such as a gNB 159.

In examples, method 200 and/or at least a part of method 200 can be considered a method of enabling control of when a terminal node 110, such as a UE 142, performs measurements associated with and/or involved in LTM, such as LTM assistance measurements 145.

In the illustrated example, the location of blocks indicates the entity performing the function(s) and/or action(s). For example, block 202 is performed by the terminal node 110, such as a UE 142.

For the further discussion of FIG. 2 it will be considered that the terminal node 110 is a UE 142.

In some examples, the UE 142 is configured for discontinuous reception (DRX).

At block 202, method 200 comprises determining whether a UE 142 is in an active period 144.

In examples, block 202 comprises determining whether a UE 142 is in an active LTM period, and/or whether a UE 142 is likely to use LTM mobility. For example, the active period may be referred to as an active LTM period. In another example, the LTM active period may be considered to be a shorter period included in the active period.

In examples, an active period 144 can be considered a period in which the UE 142, which is configured for DRX, is available for transmission and/or reception of data.

In examples, an active period 144 can be considered a period in which the UE 142, which is configured for DRX, monitors the physical downlink control channel (PDCCH).

In examples, the active period 144 can be considered a period in which the UE 142, which is configured for DRX, monitors the physical downlink control channel (PDCCH) and an additional time period following the period when UE monitors the physical downlink control channel.

In examples where the UE is not configured for DRX, the active period 144 can be considered a period in which the UE 142, has been scheduled on the physical downlink control channel (PDCCH) and a time period following the latest scheduling on the physical downlink control channel (PDCCH).

In examples, an active period 144 can be considered a period in which any related DRX timer is running requiring the UE 142 to be in active time for serving cells in a DRX group. Active time can be as defined in 3^{rd} generation partnership project (3GPP) TS 38.321.

In examples, an active period 144 can be considered a period when the UE 142 is in active time as defined in 3GPP TS 38.321.

In some examples, block 202 comprises determining whether a UE 142 is in an active period based, at least in part, on activity between the network and the UE 142.

In some examples, block 202 comprises determining whether a UE 142 is in active data transmission.

In some examples, determining whether the UE 142 is in the active period 144 comprises determining whether the UE 142 is in a DRX active period.

In examples, determining whether the UE 142 is in the active period 144 comprises determining whether the UE 142 is in a DRX active period and in a time period following the last scheduling on the physical downlink control channel (PDCCH).

In examples, determining whether the UE 142 is in the active period 144 comprises determining whether a certain time period has elapsed since the UE 142 was last scheduled on the physical downlink control channel (PDCCH).

In examples, determining whether the UE 142 is in the active period 144 comprises determining whether the UE 142 is in a DRX active period and in a time period following DRX active period.

In examples, a DRX active period 144 can be considered a period in which the UE 142, which is configured for DRX, is available for transmission and/or reception of data.

In examples, a DRX active period 144 can be considered a period in which the UE 142, which is configured for DRX, monitors the physical downlink control channel (PDCCH).

In examples, a DRX active period 144 can be considered a period in which any related DRX timer is running requiring the UE 142 to be in active time for serving cells in a DRX group. Active time can be as defined in 3^{rd} generation partnership project (3GPP) TS 38.321.

In examples, a DRX active period 144 can be considered a period when the UE 142 is in active time as defined in 3GPP TS 38.321.

Determining whether the UE 142 is in the active period 144 can comprise determining whether an inactivity timer 146 is running at the UE 142, wherein the UE 142 is in the active period 144 when the inactivity timer 146 is running at the UE 142.

The UE 142 can start an inactivity timer when scheduled, and/or in relation to any suitable defined condition or conditions being satisfied.

An inactivity timer 146 can comprise a timer of any suitable duration that runs from when the UE 142, that, in some examples, is configured for DRX, is scheduled. In examples, the UE 142 can start the inactivity timer 146 when the UE 142 is scheduled. The duration can be defined in terms of time and/or DRX cycles, for example.

In examples, the inactivity timer 146 can have a duration in the range 0 milliseconds to 3000 milliseconds (ms). In some examples, the inactivity timer 146 can have a duration in the range 1 millisecond to 2560 ms. In some examples, inactivity timer 146 can have a duration selected from: 0 ms, 1 ms, 2 ms, 3 ms, 4 ms, 5 ms, 6 ms, 8 ms, 10 ms, 20 ms, 30 ms, 40 ms, 50 ms, 60 ms, 80 ms, 100 ms, 200 ms. 300 ms, 500 ms, 750 ms, 1280 ms, 1920 ms, 2560 ms.

For example, an inactivity timer 146 can comprise a timer of any suitable duration that runs from a PDCCH occasion in which a PDCCH indicates a new uplink (UL). downlink (DL), or sidelink (SL) transmission for the medium access control (MAC) entity.

For example, an inactivity timer 146 can be an inactivity timer “drx-InactivityTimer” as defined in 3GPP TS 38.321.

By way of example, reference is made to the example of FIG. 3A.

In the example of FIG. 3A, a horizontal axis 141 represents time, with time increasing to the right of the FIG.

In the illustrated example, an inactivity timer 146 is started at a time 146A and ends at a time 146B. The duration of the inactivity timer is illustrated by the solid double headed arrow.

In the example of FIG. 3A, the inactivity timer 146 is started by the UE 142 when the UE 142 is scheduled.

In the example of FIG. 3A, the active period 144 of the UE 142 is illustrated by the dashed arrow. It can be seen in the example of FIG. 3A that the active period 144 ends when the inactivity timer 146 ends at time 146B.

In the example of FIG. 3A, the active period 144 starts when the DRX active period of the UE 142 starts. Accordingly, in the example of FIG. 3A, the active period 144 of the UE 142 starts when the DRX active period starts and ends when the inactivity timer 146 ends.

In some examples, the active period 144 of the UE 142 starts when the inactivity timer 146 starts and ends when the inactivity timer 146 ends.

Returning to the example of FIG. 2, in examples, determining whether the UE is in the active period 144 comprises determining whether an extension timer 148 is running at the UE 142, wherein the UE 142 is in the active period 144 when the extension timer 148 is running at the UE 142. The extension timer 148 may be used to extend the time the UE 142 performs, or should perform, LTM assistance measurements.

The UE 142 can start an extension timer 148 at any suitable time, and/or in relation to any suitable condition or conditions being satisfied.

An extension timer 148 can comprise a timer of any suitable duration that is configured to extend the period of an inactivity timer 146. For example, an extension timer 148 can have any suitable duration to extend the active period 144 of the UE 142 beyond the time at which the inactivity timer 146 expires. The duration can be defined in terms of time and/or DRX cycles, for example.

In examples, the extension timer 148 can have a duration in the range 0 milliseconds to 3000 milliseconds (ms). In some examples, the extension timer 148 can have a duration in the range 1 millisecond to 2560 ms. In some examples, extension timer 148 can have a duration selected from: 0 ms, 1 ms, 2 ms, 3 ms, 4 ms, 5 ms, 6 ms, 8 ms, 10 ms, 20 ms, 30 ms, 40 ms, 50 ms, 60 ms, 80 ms, 100 ms, 200 ms. 300 ms, 500 ms, 750 ms, 1280 ms, 1920 ms, 2560 ms.

The extension timer 148 may be used to extend the period during which the UE performs LTM assistance measurements. The extension timer 148 may be used to ensure that the UE 142 continues to perform LTM assistance measurements also after the period defined by the inactivity timer 146.

In examples, method 200 comprises starting the extension timer 148 when an inactivity timer 146 is started or when an inactivity timer 146 expires. Accordingly, in examples, a UE 142 can start an extension timer 148 when an inactivity timer 146 is started or when an inactivity timer 146 expires.

By way of example, reference is made to the example of FIG. 3B.

In the example of FIG. 3B, a horizontal axis 141 represents time, with time increasing to the right of the FIG.

In the illustrated example, an inactivity timer 146 is started at a time 146A and ends at a time 146B. The duration of the inactivity timer 146 is illustrated by the solid double headed arrow.

In the example of FIG. 3B, the inactivity timer 146 is started by the UE 142 when the UE 142 is scheduled.

In the example of FIG. 3B, an extension timer 148 is also used by the UE 142.

The extension timer 148 is illustrated by the dot-dash double headed arrow and is started at time 148A and expires at time 148B. As can be seen from the example of FIG. 3B, the extension timer 148 can be started when the inactivity timer 146 starts or when the inactivity timer 146 expires, and the duration of the extension timer 148 can be configured accordingly, so that the extension timer 148 expires at time 148B.

In examples where the extension timer 148 is running concurrently with the inactivity timer 146 it can be considered that the UE is in an active period 144. The UE may be considered to be in an active period when the inactivity timer 146 and/or extension timer 148 is running.

In the example of FIG. 3B, the active period 144 of the UE 142 is illustrated by the dashed arrow. It can be seen in the example of FIG. 3B that the active period 144 ends when the extension timer 148 ends at time 148B.

In the example of FIG. 3B, the active period 144 starts when the DRX active period of the UE 142 starts. Accordingly, in the example of FIG. 3B, the active period 144 of the UE 142 starts when the DRX active period starts and stops when the extension timer 148 expires.

In some examples, the active period 144 starts when the inactivity timer 146 starts and ends when the extension timer 148 ends.

Returning to the example of FIG. 2, in examples method 200 comprises receiving a request to start the extension timer 148 and starting the extension timer 148 based, at least in part, on receiving the request to start the extension timer 148. See, for example, block 212.

Accordingly, in examples, the UE 142 receives a request from the network to start the extension timer 148 and starts the extension timer 148 based, at least in part, on receiving the request.

As used herein, a request can be considered a command, and/or an instruction, and/or an order and so on.

For example, a request to start the extension timer 148 can be considered a command to start the extension timer 148, and/or an instruction to start the extension timer, and/or an order to start the extension timer 148 and so on.

For example, with reference to the example of FIG. 3B, the UE 142 can start the inactivity timer 146 at time 146A without starting an extension timer 148 and can receive a request to start an extension timer 148A from a gNB 159 prior to the inactivity timer 146 expiring and can start the extension timer 148 accordingly.

The active period 144 can therefore be extended beyond the duration of the inactivity timer 146 by the request to start the extension timer 148.

In some examples the extension timer 148 has a configured duration. The duration can be configured in any suitable way using any suitable method. For example, the duration of the extension timer 148 can be configured at the UE 142 by the access node 120 using one or more signals and/or messages. For example, duration of the extension timer 148 can be configured using for example RRC signaling. In some examples the extension timer 148 can be configured using RRC signaling and activated using other signaling for example MAC signaling or DCI and so on.

In examples, the duration of the extension timer 148 can be configured at the UE 142 prior to use of the extension timer 148. Accordingly, in examples, the duration of the extension timer 148 can be considered to be preconfigured.

Additionally, or alternatively, the duration of the extension timer 148 can be configured at the UE 142 with a request to start the extension timer 148.

In examples, method 200 comprises receiving a configuration 161 of the extension timer 148. See, for example, block 210.

Accordingly, in examples the UE 142 receives a configuration 161 of the extension timer 148 from the access node 120.

The configuration 161 can be received in any suitable way using any suitable method. For example, the configuration can be provided to the UE 142 using any suitable signaling and/or messages for example RRC or MAC signalling.

The configuration 161 can comprise information to configure any suitable aspect or aspects of the extension timer 148. For example, the configuration 161 can configure when to start the extension timer 148, and/or when to stop the extension timer 148, and/or the duration of the extension timer 148 and so on.

In examples, the configuration 161 configures the duration of the extension timer 148 and the extension timer 148 is started when the UE 142 receives a request to start the extension timer 148.

As FIG. 2 illustrates one or more actions/features of receiving, FIG. 2 also illustrates the corresponding transmitting/enabling and/or causing transmitting action(s)/feature(s). For example, from the point of view of the access node 120, at block 210, method 200 comprises transmitting, towards the UE 142, a configuration 610 of the extension timer 148.

In some examples, method 200 comprises receiving a request to stop the extension timer 148 and stopping the extension timer 148 based, at least in part, on receiving the request to stop the extension timer 148. See, for example, block 214.

Accordingly, in examples, the UE 142 receives a request from the network to stop the extension timer 148 and stops the extension timer 148 based, at least in part, on receiving the request.

For example, with reference to the example of FIG. 3B, the UE 142 can start the extension timer 148 at configured time 148A or in response to receiving a request and can allow the extension timer to run until a request to stop the extension timer 148 is received. The gNB 159 can, therefore, allow the extension timer 148 to continue past the illustrated time 148B, or can stop the extension timer 148 prior to time 148B as desired.

The active period 144 can therefore be controlled, for example by the gNB 159, to have a desired duration using a request to stop the extension timer 148.

At block 204, method 200 comprises performing LTM assistance measurements 145 when the UE 142 is in an active period 144.

LTM assistance measurements 145 may comprise any suitable measurements associated with, and/or used in, and/or involved in LTM.

Accordingly, in some examples, LTM assistance measurements 145 may comprise LTM assistance measurements introduced to facilitate LTM cell switch.

The LTM assistance measurements may comprise L1 measurements and/or L3 measurements.

In examples, LTM assistance measurements may be considered L1 assistance measurements.

In examples, LTM assistance measurements 145 may comprise any suitable measurements associated with, and/or used in, and/or involved in LTM and which are reported in at least one L1 measurement report. See, for example, block 208.

In some examples, block 204 comprises, if it is determined that the UE 142 is in an active period 144 performing LTM assistance measurements 145.

In some examples, block 204 comprises performing LTM assistance measurements 145 based, at least in part, on determining that the UE 142 is in an active period 144.

Performing LTM assistance measurements 145 can comprise performing LTM assistance measurements 145 according to an LTM measurement configuration.

In examples, method 200 comprises determining whether a request has been made for the UE 142 to start performing LTM assistance measurements 145, and performing LTM assistance measurements 145 based, at least in part, on determining whether a request has been made for the UE 142 to start performing LTM assistance measurements 145.

Accordingly, in examples, the UE 142 determines whether a request has been made for the UE 142 to start performing LTM assistance measurements 145, and performs LTM assistance measurements 145 based, at least in part, on determining whether a request has been made for the UE 142 to start performing LTM assistance measurements 145.

For example, a UE 142 can determine that the UE 142 is in an active period 144 but that no request has been made for the UE to perform LTM assistance measurements 145, and therefore the UE 142 will not perform LTM assistance measurements 145.

For example, a UE 142 can determine that the UE 142 is in an active period 144 and that a request has been made for the UE 142 to perform LTM assistance measurements 145, and therefore the UE 142 will perform LTM assistance measurements 145.

A request to perform LTM assistance measurements 145 can be received from any suitable source. In examples, the request to perform LTM assistance measurements 145 is received from the access node 120/gNB 159.

The request to perform LTM assistance measurements 145 can have any suitable form and can be made in any suitable way.

The request can be made by explicit signaling, for example an explicit request to perform LTM assistance measurements 145 can be made by the network using downlink control information (DCI), MAC, control element (CE), and/or RRC signaling.

Additionally, or alternatively, the request can be made by configuration. For example, the request can be made by configuration information received by the UE 142. For example, the request can comprise RRC reconfiguration message (e.g. RRCReconfiguration) including network indicated target cells, and/or target cell selection criteria of at least one LTM candidate cells.

Accordingly, the request to perform LTM assistance measurements 145 can be explicit (for example explicit signaling) and/or can be implicit (for example, configuration information including indicated target cells, and/or target cell selection criteria).

At block 206, method 200 comprises stopping performance, by the UE 142, of LTM assistance measurements 145 when the UE 142 is not in an active period 144.

Consequently, FIG. 2 illustrates a method 200 comprising:
determining whether a UE 142 is in an active period 144;
performing, by the UE 142, LTM assistance measurements 145 when the UE 142 is in an active period 144; and
stopping performance, by the UE 142, of LTM assistance measurements 145 when the UE 142 is not in an active period 144.

In some examples, block 206 comprises, if it is determined that the UE 142 is not in an active period 144 stop performing LTM assistance measurements 145.

In some examples, block 206 comprises not performing LTM assistance measurements 145 based, at least in part, on determining that the UE 142 is not in an active period 144.

Accordingly, in examples, at block 206 method 200 can comprise stopping performance of LTM assistance measurements 145 when an active period 144 has ended or not starting LTM assistance measurements 145 when a UE 142 is not in an active period 144.

In some examples, method 200 comprises receiving a request to continue performance of LTM assistance measurements 145 until a request to stop is received or the UE 142 leaves connected mode.

Accordingly, in examples, the UE 142 receives a request to continue performance of LTM assistance measurements 145 until a request to stop is received or the UE 142 leaves connected mode.

In such examples, the UE 142 can be considered to be in an active period 144 from receiving the request to continue performance of LTM assistance measurements 145 until a request to stop is received or the UE 142 leaves connected mode.

From the point of view of the access node 120, which in the example of FIG. 2 is a gNB 159, method 200 can comprise transmitting at least one signal and/or at least one message towards the terminal node 110, which in the example of FIG. 2 is a UE 142.

For example, from the point of view of the access node 120, method 200 can comprise transmitting at least one request towards the UE 142 to control and/or for use in controlling performance of LTM assistance measurements 145 at/by the UE 142.

In the example of FIG. 2, at block 212, method 200 comprises transmitting, towards a UE 142, a request 163 to continue performing LTM assistance measurements 145. In some examples, the UE 142 is configured for DRX.

The request 163 at block 212 can have any suitable form.

In some examples, the request 163 at block 212 comprises a request to continue performance, by the UE 142, of LTM assistance measurements 145 until a request to stop is received or the UE 142 leaves connected mode.

In some examples, the request 163 at block 212 comprises a request to start an extension timer 148.

At block 214, method 200 comprises transmitting, towards the UE 142, a request 164 to stop performing LTM assistance measurements 145.

Consequently, FIG. 2 illustrates a method 200 comprising:
transmitting, towards a UE 142, a request 163 to continue performing LTM assistance measurements 145; and
transmitting, towards the UE 142, a request 164 to stop performing LTM assistance measurements 145. In some examples, the UE 142 is configured for DRX.

The request 164 at block 214 can have any suitable form.

In some examples, the request 164 at block 214 comprises an explicit request to stop performing LTM assistance measurements 145 following a request 163 to continue performance, by the UE 142, of LTM assistance measurements 145 until a request to stop is received.

In some examples, the request 164 at block 214 comprises a request to stop an extension timer 148.

Consequently, in some examples, transmitting, towards the UE 142, of a request 163 to continue performing LTM assistance measurements 145 comprises transmitting, towards the UE 142, a request to start an extension timer 148, and transmitting, towards the UE 142, of a request 164 to stop performing LTM assistance measurements 145 comprises transmitting, towards the UE 142, of a request to stop the extension timer 148.

In some examples, method 200 comprises determining that at least one LTM assistance measurement condition is satisfied and performing LTM assistance measurements 145 based, at least in part, on determining that at least one LTM assistance measurement condition is satisfied.

Accordingly, in examples the UE 142 determines that at least one LTM assistance measurement condition is satisfied and performs LTM assistance measurements 145 based, at least in part, on determining that at least one LTM assistance measurement condition is satisfied.

In examples, at least one LTM assistance measurement condition can be considered at least one LTM assistance measurement pre-condition. Accordingly, in examples, method 200 comprises determining that at least one LTM assistance measurement pre-condition is satisfied and performing LTM assistance measurements 145 based, at least in part, on determining that at least one LTM assistance measurement pre-condition is satisfied.

The at least one LTM assistance measurement condition can comprise any suitable condition or conditions. In examples, the at least one LTM assistance measurement condition can comprise at least one condition to enable the UE 142 to be able to perform LTM assistance measurements 145. For example, in some examples, the UE 142 is unable to perform LTM assistance measurements 145 before the at least one LTM assistance measurement condition is satisfied.

For example, the at least one LTM assistance measurement condition can comprise a condition that an L3 measurement including the target cell has been sent to the network.

For example, the at least one LTM assistance measurement condition can comprise a condition that a request has been received for the UE 142 to start performing LTM assistance measurements.

At block 208, method 200 comprises transmitting at least one measurement report 154 based, at least in part, on at least part of the LTM assistance measurements 145.

The at least one measurement report can comprise any suitable measurement report 154 configured to provide any suitable information of the LTM assistance measurements 145. For example, the at least one measurement report 154 can comprise any suitable measurement made in the LTM assistance measurements 145.

For example, LTM assistance measurements 145 can comprise L1 measurements and/or L3 measurements which are reported in at least one L1 measurement report.

For example, LTM assistance measurement 145 can comprise L1 reference signal received power (RSRP) and/or L3-RSRP measurements which are reported in an L1 measurement report.

For example, the LTM assistance measurements can be reported in radio resource control (RRC) MeasResults information element. In examples, MeasResults can cover measured results for intra-frequency, inter-frequency, inter-radio access technology (RAT) mobility and/or new radio (NR) sidelink communication/discovery.

In examples, NR neighbour cell measurements are contained in measResultNeighCells element in measResultListNR per physical cell ID (PCI).

Method 200 can comprise transmitting any suitable number of measurement reports 154 at any suitable time or times in the method 200. For example, in examples, the UE 142 can send at least one measurement report 154 after making any number of LTM assistance measurements 145.

In some examples, the UE 142 can transmit at least one measurement report 154 when and/or after an active period 144 of the UE 142 has ended.

In examples, a method is proposed which enables control of when the UE performs LTM assistance measurements based on the activity between network and UE for example in terms of data exchange.

In some examples, the UE will perform LTM assistance measurements when the UE is in active data transmission for example when the UE is in Active time or when the Inactivity timer is running in the UE. In examples, when the Inactivity timer is not running in the UE (or UE is not in active time) the UE is not required to perform LTM measurements and/or reporting.

In examples, if the UE is configured with DRX, when any related DRX timer requiring the UE to be in Active Time for a Serving Cells in a DRX group, the UE will perform LTM L1 measurements.

In examples, the UE continues the measurements and/or reporting for an additional time period after the Inactivity timer has expired. Hence, the measurements and/or reporting requirements applies for an additional time period after the Inactivity timer has expired. This additional time period can be offset from when the Inactivity timer is started or when the Inactivity timer expires.

In examples, the additional LTM L1 measurement timer is LTM specific extension timer or it is a time period expressed by other means like DRX cycles.

In examples, the network explicitly starts and/or stops the LTM L1 measurements and/or LTM L1 measurement extension timer.

In some examples, the method can be controlled by UE based on network assistance control information. Hence, in examples. there is no need to continue network enabling and disabling of the LTM assistance measurements and/or reporting.

Examples of the disclosure are advantageous and/or provide technical benefits.

For example, examples of the disclosure provide for a UE to perform LTM assistance measurements when LTM mobility is needed or it is likely that LTM mobility will be needed, but can otherwise save resources, for example reducing power consumption by the UE.

For example, examples of the disclosure provide control over when a UE performs LTM assistance measurements, reducing interruptions on the serving cell from the UE performing L1/L3 measurements on one or more neighboring cells.

For example, examples of the disclosure provide for a UE to perform (and/or report) relevant LTM assistance measurements when needed (for example when it is predicted that there is a need for LTM mobility) and can report these to the network in a timely manner. However, when it is predicted there is little/no need for LTM mobility, the UE is not required to perform and/or report LTM assistance measurements.

FIG. 4 illustrates an example of a method 400.

Method 400 can be performed by any suitable apparatus comprising any suitable means for performing method 400, for example an apparatus as described in relation to FIG. 10A and/or FIG. 10B.

In examples, method 400 can be performed by a UE 142, or by a control device configured to control the functioning thereof, when installed therein.

At block 402, method 400 comprises determining whether a UE 142 is in an active period 144. In some examples, the UE 142 is configured for DRX.

At block 404, method 400 comprises causing performance, by the UE 142, of LTM assistance measurements 145 when the UE 142 is in an active period 144.

At block 144, method 400 comprises stopping performance, by the UE 142, of LTM assistance measurements 145 when the UE 142 is not in an active period 144.

Consequently, FIG. 4 illustrates a method 400 comprising:
determining whether a UE 142 is in an active period 144;
causing performance, by the UE 142, of LTM assistance measurements 145 when the UE 142 is in an active period; and
stopping performance, by the UE 142, of LTM assistance measurements 145 when the UE 142 is not in an active period 144.

FIG. 5 illustrates an example of a method 500.

Method 500 can be performed by any suitable apparatus comprising any suitable means for performing method 500. For example, an apparatus as described in relation to FIGS. 10A and/or 10B.

In examples, method 500 can be performed by an access node 120, such as a gNB 159, or by a control device configured to control the functioning thereof, when installed therein.

At block 502, method 500 comprises causing transmission, to a UE 142, of a request 163 to continue performing LTM assistance measurements 145. In some examples, the UE 142 is configured for DRX.

At block 504, method 500 comprises causing transmission, to the UE 142, of a request 164 to stop performing LTM assistance measurements 145.

Consequently, FIG. 5 illustrates a method 500 comprising:
causing transmission, to a UE 142, of a request 163 to continue performing LTM assistance measurements 145; and
causing transmission, to the UE 142, of a request 164 to stop performing LTM assistance measurements 145.

In the following examples a number of different options are presented of how the method can be realized. In the following examples, NR and NR signaling are used as examples. Additionally, the examples assume DRX is configured. However, examples should not be seen as being limited to NR or use of DRX but can also be applied to other systems including legacy and future systems like 6G.

Examples of the disclosure can be realized in many different ways.

In the following various different options are described. The ‘options’ also refer to the illustration in the signalling diagrams or message sequence charts (MSC) in FIGS. 6, 7, 8A, 8B, 9A, and/or 9B.

Option 1 (FIG. 7): Method is based on the UE Inactivity timer, e.g. solely based on the UE Inactivity timer. With regard to option 1, pre-conditions in box 11 could be: UE will initiate LTM L1 measurement on the TargetCell once the L3 measurement including the TargetCell has been sent to the network.

Option 2 (also see FIG. 7): Method is based on requested LTM measurement and UE Inactivity timer. The method is similar as option 1 except for the pre-conditions in box 11: LTM measurement has been requested to be performed. LTM measurement(s) may be requested by the network or the UE. The request can either include network indicated target cell(s), or UE RRC configured target cell selection of one or more LTM candidate cells.

Option 3 (FIGS. 8A and 8B): Additional timer delay (extension timer) following the expiry of the UE Inactivity timer. This option can be used together with either of option 1 or option 2. The timer may be expressed by time (in seconds) or DRX cycles or similar.

Option 4 (FIGS. 9A and 9B): In this method the network explicitly requests L1 LTM measurements. This option can work as standalone solution or can be combined with any of the options 1 to 3.

Requests from the network may overwrite current measurement status, e.g.the request may instruct the UE to start or stop measurements at any time.

It should be noted that any combination of above options could be possible.

Next, with reference to FIGS. 6, 7, 8A, 8B, 9A, and 9B details of r options 1, option 2, option 3 and option 4 are discussed.

FIGS. 6, 7, 8A, 8B, 9A, and 9B illustrate signalling between a UE 142, a primary cell 166 (PCell) and a target cell 168 (TargetCell).

FIG. 6 shows, by way of example, some initial steps (block 2) or blocks which may be performed before methods according to one or more of the options 1, option 2, option 3, or option 4.

With reference to the example of FIG. 6, it is assumed that the UE is in connected mode (block 1). During connected mode the UE is configured with one or more LTM candidate cell (block 3). The TargetCell is a configured LTM candidate cell. In examples the LTM candidate cells are candidates on the same carrier as the serving cell. Hence, the candidates are intra-frequency candidates. This assumption is just to simplify the explanation, but examples also applies to, for example, candidate cell located on another carrier than the serving cell (hence, either inter-frequency or inter-RAT candidate cells).

At block 4, the UE performs normal intra-frequency L3 measurements. Hence, at some point the UE will detect one or more intra-frequency neighboring cells—possibly including one or more of the configured LTM candidate cells. The UE is configured to detect and measure any synchronization signal block (SSB) from TargetCell. The UE is configured to process the measurements (block 6).

Based on the measurement and configured reporting events (assuming re-using L3 measurement reporting framework) an event may trigger a measurement report being transmitted by the UE to the network in block 7 and 8.

Having received the measurement report from the UE, the network is aware when the UE has detected and measured cell which may be one of the configured candidate cells (block 9).

Network may use the reported results for any further network decided action among other initiate LTM procedures if network involvement is needed.

Option 1 will now be discussed with reference to FIG. 7.

In the example of FIG. 7 it is assumed that if the UE has been configured with one or more LTM candidate cells, the UE may initiate LTM L1 measurements based on pre-defined triggers on UE side. In examples, such trigger could be that the UE has detected, measured, and sent a measurement report to the network. FIG. 7 illustrates the principle.

At block 11 the UE evaluates if there are any pre-conditions for initiating LTM L1 measurements. In examples it is assumed that the precondition is that the UE has sent a measurement report to the network including at least one of the configured LTM candidate cells. Hence, the UE will initiate LTM L1 measurement on the TargetCell once the L3 measurement including the TargetCell has been sent to the network. Block 21 illustrates the time period when the UE performs LTM L1 measurements.

At block 12, once the UE is scheduled, the UE will start the Inactivity timer (block 13). The start of the inactivity timer also triggers the UE to initiate performing LTM L1 measurements according to the TargetCell configuration (as the TargetCell was reported to network and hence the pre-condition for performing LTM L1 measurements is fulfilled). In examples, there may be more than one cell (TargetCells).

At blocks 17, 18 and 19, the UE is performing and processing LTM L1 measurements. At block 20 the UE inactivity timer expires. This block triggers the UE to stop performing the LTM L1 measurements (block 22).

As can be seen, using this approach, the UE will perform LTM L1 measurement while the UE inactivity timer is running. Otherwise, the UE may not be required to perform those measurements. For example, the UE may be configured to perform LTM L1 measurements only when the UE inactivity timer is running. This can significantly reduce the UE measurement burden related to LTM L1 measurements.

Option 2 is similar to Option 1 and same MSC (FIG. 7) can be used for explaining the method in detail.

With regard to option 2, it is assumed that if the UE has been configured with one or more LTM candidate cells, the UE will initiate LTM L1 measurements based on pre-defined triggers on UE side.

However, compared to Option 1, the LTM L1 measurement are performed, e.g. only performed, if these have been requested to be performed. This request could either be network or UE requested. Otherwise, the principles are the same as option 1.

Option 3 (block 23) will now be discussed with reference to FIGS. 8A and 8B. The signalling diagram of FIG. 8B is a continuation of the signalling diagram of FIG. 8A.

In the example of FIGS. 8A and 8B, it is assumed that if the UE has been configured with one or more LTM candidate cells, the UE will initiate LTM L1 measurements based on pre-defined triggers (optional) on UE side.

At block 24 the UE evaluates if there are any pre-conditions (if configured) for initiating LTM L1 measurements. In the example of FIGS. 8A and 8B, it is assumed that the precondition is fulfilled e.g. UE sent a measurement report to the network including at least one of the configured LTM candidate cells. Hence, the UE will initiate LTM L1 measurement on the TargetCell.

At block 25, once the UE is scheduled, the UE will start the Inactivity timer (block 26). Additionally, the UE may start another timer, an extension timer, e.g. ‘LTM L1 extension’ timer (block 27). This timer is to guard that the UE will continue performing LTM L1 measurement for a period after the UE inactivity timer has expired. In another option this extension timer is started once the inactivity timer expires (blocks 34 and 35).

While the LTM L1 extension timer is running the UE will perform LTM L1 measurements. The timer and timer length can be either in real time (ms or second etc) or it can be expressed by other means such as for example a number of DRX cycles.

In the illustrated example, the start of the inactivity timer triggers the UE to initiate performing LTM L1 measurements according to the TargetCell configuration (as the TargetCell was reported to network and hence the pre-condition for performing LTM L1 measurements is fulfilled). There can be more than one cell (TargetCells).

At blocks 31, 32 and 33, the UE is performing LTM L1 measurements. The UE receives LTM L1 measurement reference signal (RS) for example SSB and/or Channel State Information Reference Signal (CSI-RS) from the at least one TargetCell. At block 34 the UE inactivity timer expires. However, different from Option 1 and 2, the UE will at the time when the inactivity timer expires evaluate if the LTM L1 extension timer is running. If the LTM L1 extension timer is running, the UE will continue performing LTM L1 measurements (block 36).

As illustrated at block 35, one option is that the LTM L1 extension timer is started once the UE inactivity timer expires.

While LTM L1 extension timer is running the UE will continue to perform LTM L1 measurements. This is illustrated in blocks 36, 37 and 38.

When the LTM L1 extension timer expires (block 39) the UE may stop performing LTM L1 measurements (block 43).

Block 42 illustrates a time period during which the UE performs LTM L1 measurements. Block 41 relates to the case when the extension timer is started when the inactivity timer is started. Block 40 relates to the case when the extension timer is started when the inactivity timer expires.

As can be seen this method means that the UE will perform LTM L1 measurements for a longer period than for example for option 1 and 2. The benefit from these additional LTM L1 measurements would for example be that in case of new data arriving and triggering further LTM L1 measurements, the UE would already have some measurement available—hence, reducing any possible measurement delay.

Option 4 (block 44) will now be discussed with reference to FIGS. 9A and 9B. The signalling diagram of FIG. 9B is a continuation of the signalling diagram of FIG. 9A.

In the example of FIGS. 9A and 9B. it is assumed that if the UE has been configured with one or more LTM candidate cells, the UE will initiate LTM L1 measurements based on pre-defined triggers (optional) on UE side.

It is assumed that examples of option 4 can work independently from the other listed options or it may work together with any of the options (combination of options).

In the example of FIGS. 9A and 9B, it is assumed that the UE will perform LTM L1 measurement once being in connected mode and the pre-conditions for performing the LTM L1 measurements are fulfilled (block 45) (e.g. as explained in the context of option 1).

At block 46, once the UE is scheduled, the UE will start the Inactivity timer (block 47). The inactivity timer may be agreed to be restarted each time the UE is scheduled (block 49, block 50).

In block 48 the network explicitly indicates to the UE to apply an LTM L1 extension timer (one option) or simply just command the UE to continue performing LTM L1 measurements (e.g. until explicitly requested to stop or leaving connected mode).

When the inactivity timer is running, the UE is configured to perform and process LTM L1 measurements (block 51, block 52, block 53, block 54).

When the UE inactivity timer expires (block 55) the UE may check whether the UE has been requested to continue performing LTM L1 measurements or check whether the extension timer is running.

If the UE has been requested to continue LTM L1 measurements, or if the extension timer is running, or if UE has not received and explicitly request to stop the LTM L1 measurements, the UE will continue to perform those measurements. Otherwise the UE may decide to stop the measurements.

At block 56, the UE receives the explicit request to stop the LTM L1 measurements. Based on the request the UE stops performing LTM L1 measurements in block 59.

FIG. 10A illustrates an example of a block diagram of an apparatus 130. The apparatus 130 may be a controller of an apparatus or device such as a terminal node 110, for example a UE 164, or network node 168 such as an access node 120. The apparatus 130 may be considered a controller configured to control a device such as a UE or a network node.

In examples, the apparatus 130 can be comprised in an electronic device. Accordingly, in examples, there is provided an electronic device comprising an apparatus 130 as described herein.

Implementation of a controller 130 may be as controller circuitry. The controller 130 may be implemented in hardware alone, have certain aspects in software including firmware alone or can be a combination of hardware and software (including firmware).

In some examples, the apparatus 130 is or is comprised in the UE 164.

In some examples, the apparatus 130 is or is comprised in the access node 120.

As illustrated in FIG. 10A the controller 130 may be implemented using instructions that enable hardware functionality, for example, by using executable instructions of a computer program 136 in a general-purpose or special-purpose processor 132 that may be stored on a computer readable storage medium (disk, memory etc) to be executed by such a processor 132.

The processor 132 is configured to read from and write to the memory 134. The processor 132 may also comprise an output interface via which data and/or commands are output by the processor 132 and an input interface via which data and/or commands are input to the processor 132.

The memory 134 stores a computer program 136 comprising computer program instructions (computer program code) that controls the operation of the apparatus 130 when loaded into the processor 132. The computer program instructions, of the computer program 136, provide the logic and routines that enables the apparatus to perform the methods illustrated in the accompanying FIGS. The processor 132 by reading the memory 134 is able to load and execute the computer program 136.

In examples, the apparatus 130 comprises:
at least one processor 132; and
at least one memory 134 including computer program code
the at least one memory 134 and the computer program code configured to, with the at least one processor 132, cause the apparatus 130 at least to perform:
determining whether a UE 142 is in an active period 144;
causing performance, by the UE 142, of LTM assistance measurements 145 when the UE 142 is in an active period; and
stopping performance, by the UE 142, of LTM assistance measurements 145 when the UE 142 is not in an active period 144.

In examples, the apparatus 130 comprises:
at least one processor 132; and
at least one memory 134 including computer program code
the at least one memory 134 and the computer program code configured to, with the at least one processor 132, cause the apparatus 130 at least to perform:
causing transmission, to a UE 142, of a request 163 to continue performing LTM assistance measurements 145; and
causing transmission, to the UE 142, of a request 164 to stop performing LTM assistance measurements 145.

In examples, the apparatus 130 comprises:
at least one processor 132; and
   at least one memory 134 including computer program code,
   the at least one memory storing instructions that, when executed by the at least one processor 132, cause the apparatus at least to:
determine whether a UE 142 is in an active period 144;
cause performance, by the UE 142, of LTM assistance measurements 145 when the UE 142 is in an active period; and
stop performance, by the UE 142, of LTM assistance measurements 145 when the UE 142 is not in an active period 144.

In examples, the apparatus 130 comprises:
at least one processor 132; and
   at least one memory 134 including computer program code,
   the at least one memory storing instructions that, when executed by the at least one processor 132, cause the apparatus at least to:
cause transmission, to a UE 142, of a request 163 to continue perform LTM assistance measurements 145; and
cause transmission, to the UE 142, of a request 164 to stop performing LTM assistance measurements 145.

As illustrated in FIG. 10A, the computer program 136 may arrive at the apparatus 130 via any suitable delivery mechanism 162. The delivery mechanism 162 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 136. The delivery mechanism may be a signal configured to reliably transfer the computer program 136. The apparatus 130 may propagate or transmit the computer program 136 as a computer data signal.

Computer program instructions for causing an apparatus to perform at least the following or for performing at least the following:
determining whether a UE 142 is in an active period 144;
causing performance, by the UE 142, of LTM assistance measurements 145 when the UE 142 is in an active period; and
stopping performance, by the UE 142, of LTM assistance measurements 145 when the UE 142 is not in an active period 144.

Computer program instructions for causing an apparatus to perform at least the following or for performing at least the following:
causing transmission, to a UE 142, of a request 163 to continue performing LTM assistance measurements 145; and
causing transmission, to the UE 142, of a request 164 to stop performing LTM assistance measurements 145.

The computer program instructions may be comprised in a computer program, a non-transitory computer readable medium, a computer program product, a machine readable medium. In some but not necessarily all examples, the computer program instructions may be distributed over more than one computer program.

Although the memory 134 is illustrated as a single component/circuitry it may be implemented as one or more separate components/circuitry some or all of which may be integrated/removable and/or may provide permanent/semi-permanent/dynamic/cached storage.

In examples the memory 134 comprises a random access memory 158 and a read only memory 160. In examples the computer program 136 can be stored in the read only memory 158. See, for example, FIG. 10B.

Although the processor 132 is illustrated as a single component/circuitry it may be implemented as one or more separate components/circuitry some or all of which may be integrated/removable. The processor 132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a user equipment or a network node, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying FIGS. may represent steps in a method and/or sections of code in the computer program 136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The apparatus 130 can, in examples, comprise means for:
determining whether a UE 142 is in an active period 144;
causing performance, by the UE 142, of LTM assistance measurements 145 when the UE 142 is in an active period; and
stopping performance, by the UE 142, of LTM assistance measurements 145 when the UE 142 is not in an active period 144.

The apparatus 130 can, in examples, comprise means for:
causing transmission, to a UE 142, of a request 163 to continue performing LTM assistance measurements 145; and
causing transmission, to the UE 142, of a request 164 to stop performing LTM assistance measurements 145.

In examples, an apparatus 130 can comprise means for performing one or more methods, or at least part of one or more methods, as disclosed herein.

In examples, an apparatus 130 can be configured to perform one or more methods, or at least a part of one or more methods, as disclosed herein.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus comprising:
at least one processor; and
at least one memory including computer program code;
the at least one memory storing instructions that, when executed by the at least one processor, cause the apparatus at least to perform:
determining whether a user equipment, UE, is in an active period;
causing performance, by the UE, of L1/L2-Triggered Mobility, LTM, assistance measurements when the UE is in an active period; and
stopping performance, by the UE, of LTM assistance measurements when the UE is not in an active period.

2. The apparatus as claimed in claim 1, wherein the UE is configured for discontinuous reception, DRX, and wherein determining whether the UE is in the active period comprises determining whether the UE is in a DRX active period.

3. The apparatus as claimed in claim 1, wherein determining whether the UE is in the active period comprises determining whether an inactivity timer is running at the UE, wherein the UE is in the active period when the inactivity timer is running at the UE.

4. The apparatus as claimed in claim 1, wherein the instructions, when executed by the at least one processor, further cause the apparatus to:
determine whether a request has been made for the UE to start performing LTM assistance measurements; and
cause performance, by the UE, of LTM assistance measurements based, at least in part, on determining whether a request has been made for the UE to start performing LTM assistance measurements.

5. The apparatus as claimed in claim 1, wherein determining whether the UE is in the active period comprises determining whether an extension timer is running at the UE, wherein the UE is in the active period when the extension timer is running at the UE.

6. The apparatus as claimed in claim 5, wherein the instructions, when executed by the at least one processor, further cause the apparatus to: receive a configuration of the extension timer.

7. The apparatus as claimed in claim 5, wherein the instructions, when executed by the at least one processor, further cause the apparatus to:
start the extension timer when an inactivity timer is started or when an inactivity timer expires.

8. The apparatus as claimed in claim 5, wherein the instructions, when executed by the at least one processor, further cause the apparatus to:
receive a request to start the extension timer; and
start the extension timer based, at least in part, on receiving the request to start the extension timer.

9. The apparatus as claimed in claim 5, wherein the extension timer has a configured duration.

10. The apparatus as claimed in claim 8, wherein the instructions, when executed by the at least one processor, further cause the apparatus to:
receive a request to start the extension timer; and
start the extension timer based, at least in part, on receiving the request to start the extension timer;
receive a request to stop the extension timer; and
stop the extension timer based, at least in part, on receiving the request to stop the extension timer.

11. The apparatus as claimed in claim 1, wherein the instructions, when executed by the at least one processor, further cause the apparatus to:
receive a request to continue causing performance, by the UE, of LTM assistance measurements until a request to stop is received or the UE leaves connected mode.

12. The apparatus as claimed in claim 1, wherein the instructions, when executed by the at least one processor, further cause the apparatus to:
determine that at least one LTM assistance measurement condition is satisfied; and
cause performance, by the UE, of LTM assistance measurements based, at least in part, on determining that at least one LTM assistance measurement condition is satisfied.

13. The apparatus as claimed in claim 1, wherein causing performance, by the UE, of LTM assistance measurements comprises causing performance, by the UE, of LTM assistance measurements according to an LTM measurement configuration.

14. The apparatus as claimed in claim 1, wherein the instructions, when executed by the at least one processor, further cause the apparatus to:
cause transmission of at least one measurement report based, at least in part, on at least part of the LTM assistance measurements.

15. (canceled)

16. A method comprising:
determining whether a user equipment, UE, is in an active period;
causing performance, by the UE, of L1/L2-Triggered Mobility, LTM, assistance measurements when the UE is in an active period; and
stopping performance, by the UE, of LTM assistance measurements when the UE is not in an active period.

17. The method as claimed in claim 16, wherein the UE is configured for discontinuous reception, DRX, and wherein determining whether the UE is in an active period comprises determining whether the UE is in a DRX active period.

18. The method as claimed in claim 16, wherein determining whether the UE is in an active period comprises determining whether an inactivity timer is running at the UE, wherein the UE is in an active period when the inactivity timer is running at the UE.

19. The method as claimed in claim 16, comprising:
determining whether a request has been made for the UE to start performing LTM assistance measurements; and
causing performance, by the UE, of LTM assistance measurements based, at least in part, on determining whether a request has been made for the UE to start performing LTM assistance measurements.

20-23. (canceled)

24. An apparatus comprising
at least one processor; and
at least one memory including computer program code;
the at least one memory storing instructions that, when executed by the at least one processor, cause the apparatus at least to perform:
causing transmission, towards a UE of a request to continue performing LTM assistance measurements; and
causing transmission, towards the UE, of a request to stop performing LTM assistance measurements.

25. The apparatus as claimed in claim 24, wherein causing transmission, towards the UE, of a request to continue performing LTM assistance measurements comprises causing transmission, to the UE, of a request to start an extension timer; and
wherein causing transmission, towards the UE, of a request to stop performing LTM assistance measurements comprises causing transmission, to the UE, of a request to stop the extension timer.
